(19) United States
(12) Patent Application Publication
(10) Pub. No.: US 2011/0270770 A1
(43) Pub. Date: Nov. 3, 2011

(54) CUSTOMER PROBLEM ESCALATION PREDICTOR

(75) Inventors: Russell E. Cunningham, Austin, TX (US); Jason W. Hayes, Universal City, TX (US); Satish K. Rao, Austin, TX (US)

(73) Assignee: IBM Corporation, Armonk, NY (US)

(21) Appl. No.: 12/770,819

(22) Filed: Apr. 30, 2010

(51) Int. Cl. G06Q 10/00; G06F 15/18; G06N 3/08; G06N 5/02

(52) U.S. Cl. 705/304; 706/12; 706/52; 706/25

(57) ABSTRACT

The likelihood of a problem report being escalated to a critical status in a customer service environment is predicted by receiving historical Problem Management Records for which associated problems have been resolved and final criticality statuses have been determined, analyzing the historical Problem Management Records using at least one trainable data mining process to produce a prediction output for each historical Problem Management Record, validating the prediction output against the final criticality statuses, training the data mining process according to the validation, and, subsequently, analyzing an unresolved Problem Management Record by the trained analysis module to produce a prediction indicator and a confidence indicator for unresolved Problem Management Record to be re-classified as critical status. The unresolved Problem Management Record is escalated to critical status level responsive to the prediction indicator and the confidence indicator exceeding a predetermined threshold.

### CROSS-REFERENCE TO RELATED APPLICATIONS (CLAIMING BENEFIT UNDER 35 U.S.C. 120)

None.

### FEDERALLY SPONSORED RESEARCH AND DEVELOPMENT STATEMENT

This invention was not developed in conjunction with any Federally sponsored contract.

### MICROFICHE APPENDIX

Not applicable.

### INCORPORATION BY REFERENCE

None.

### FIELD OF THE INVENTION

The invention generally to systems and computerized methods to manage open customer complaint and trouble tickets in the customer service and customer relationship management fields.

### BACKGROUND OF INVENTION

Many companies, government entities, and professional practices (hereinafter referred to collectively as “business entities”) find that a considerable portion of their resources, such as personnel, computers, telephone usage, internet usage, etc., are consumed by handling of customer complaints and inquiries regarding the business entity's products or services.

Most such business entities organize their customer service department into layers or levels of “triage”, so that when a customer initially contacts a customer service, much of the service is automated or handled by lower-skilled representatives. For example, to make an initial complaint, a customer may first be required to send a letter by mail, to fill out a form or message on a web site, or to navigate through a series of voice menus on a telephone. Many problems or complaints are handled at this level successfully.

However, for the percentage of complainants whose problem is not resolved at this first level of customer service, the “problem ticket” or complaint may be “escalated” to the next higher level of customer service, in which more skilled customer service agents may apply their expertise and authority to resolve the situation. And, after some effort and time, unresolved problems may be further escalated to yet additional higher levels, at each which the responding customer service agents have greater or more specific expertise and/or authority to resolve the situation.

Much of the escalation, however, is not due solely to technical issues—e.g. whether or not the product has been repaired or the service corrected. Instead, many times, escalation occurs because a customer is not satisfied with the resolution offered or made by the currently-assigned service agent. For example, if a retail store sells a household appliance to a purchaser and it is dented or scratched during deliver, the first level customer service may offer the customer a choice of (a) a partial refund in which the customer would keep the slightly damaged appliance but receive monetary compensation, or (b) a replacement new appliance which would be delivered within perhaps 5 business days. However, the customer may not want the refund, and may also wish to demand a replacement product in a quicker delivery time than the offered or projected 5 days.

While this example is one of a retail scenario, similar situations occur in business-to-business relationships, as well, with the sales of everything from office supplies, to travel arrangements, to high tech products (computers, faxes, cellular telephones, etc.), as well as services such as insurance, office cleaning, etc.

Most customer service organizations recognize that this escalation process may lead to exasperation of the customer's frustration as it requires time and effort to move the problem handling from the initial level of customer service to the eventual level where a satisfactory solution can be had.

But, shortening this cycle of delays for escalation has been elusive for business entities for decades. It is difficult to know in advance which customers who are making an initial complaint to a business entity are most likely to escalate the support situation as they are not getting the expected support through the normal support channels. One known attempted solution to this problem, for example, includes proactive interactions between customer account teams and the customers.

Another known attempted solution is to open a formal complaint with the company's complaint offices or through channels such as duty managers. And, yet another known attempted solution is to take several metrics and analyze them individually.

Among the drawbacks of these existing methods are that the company has to react to the already-escalated situation rather than addressing it before it happens proactively.

Additionally, many customers who do not escalate but still have unmet expectations are dissatisfied and this may be reflected in future sales.

### SUMMARY OF THE INVENTION

The likelihood of a problem report being escalated to a critical status in a customer service environment is predicted by receiving historical Problem Management Records for which associated problems have been resolved and final criticality statuses have been determined, analyzing the historical Problem Management Records using at least one trainable data mining process to produce a prediction output for each historical Problem Management Record, validating the prediction output against the final criticality statuses, training the data mining process according to the validation, and, subsequently, analyzing an unresolved Problem Management Record by the trained analysis module to produce a prediction indicator and a confidence indicator for unresolved Problem Management Record to be re-classified as critical status. The unresolved Problem Management Record is escalated to critical status level responsive to the prediction indicator and the confidence indicator exceeding a predetermined threshold.

### BRIEF DESCRIPTION OF THE DRAWINGS

The description set forth herein is illustrated by the several drawings.

FIG. 1 illustrates the logical processes of training the analysis modules.

FIG. 2 depicts an overall functional view of the prototype which was implemented using a computer platform and one or more computer programs interfaced to a customer trouble ticket database

FIGS. 3 and 4 set forth experimental results of testing of one prototype.

FIG. 5 provides a lift chart illustration of the experimental test results illustrated by FIGS. 3 and 4.

FIG. 6 illustrates the hybrid model implemented in our prototype using software and computing platform having a microprocessor, computer readable storage memory, and suitable operating system software in addition to custom logical processes.

### DETAILED DESCRIPTION OF EMBODIMENT(S) OF THE INVENTION

The inventors of the present invention have recognized that an additional solution is required to facilitate proactive handling of customer complaint and feedback situations which could lead to improved customer satisfaction while reducing or eliminating the time and frustration of following traditional models of escalation of problem tickets.

Methods and systems according to the invention identify support metrics that are referred to as “customer pain indicators”, a term which we create and define in the present disclosure. These methods and systems use these new metrics to derive additional “pain metrics”, and the combine and analyze the individual pain metrics to predict customer escalations. In so doing, this process avoids dependence on regular customer interactions by the account team, providing an associated cost savings in the operation of the customer service department, and also realizes further cost savings in the form of duty manager time and analysis of individual metrics which can be error prone.

### Protoyped Embodiment

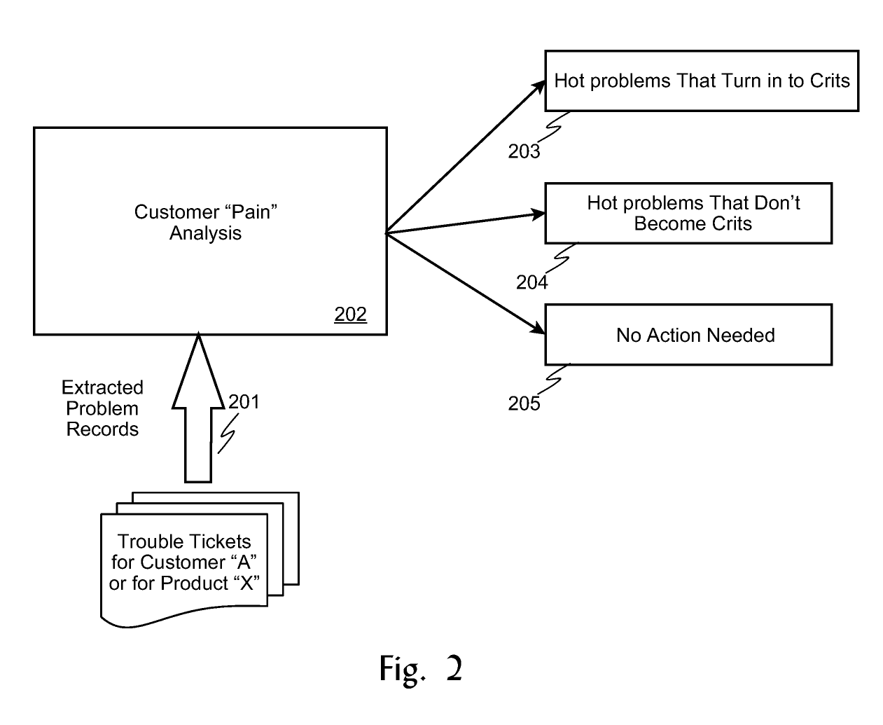

A prototype of the following embodiment of the invention was created and tested against actual customer trouble tickets in a high-tech computer services company. As shown in FIG. 2, an overall functional view of the prototype which was implemented using a computer platform and one or more computer programs interfaced to a customer trouble ticket database included a number of trouble tickets (201) extracted from such a database for a particular customer which were analyzed (202) according to the customer's “pain” in the situation, yielding predictions of which trouble tickets would eventually escalate to a critical level (e.g. “crit”) (203), which trouble tickets that started as a hot problem would not eventually become a crit (204), and which trouble tickets would not become crits (205).

The following generalized process was developed, experimentally tested and verified on a real, historical set of trouble tickets which had been handled to completing, comparing the predictive output of the prototype to the actual resolutions of the trouble tickets in real life (referred to as “Problem Management Reports” or PMR):
(a) The system automatically extracted problem records (a.k.a. “problem tickets” and “trouble tickets”) PMR data at a given time for a given customer.
(b) The system calculated certain necessary intermediate variables using hybrid data mining methods in analysis modules, including logistic regression and discriminant analysis methods, on the problem ticket data.
(c) Each of the analysis modules output a value which indicated whether a given PMR is/was likely to become a critical situation or not.
(d) The system then combined the outputs of the two analysis moduels to improve the probability of predicting subsequent problem reports from the same customer becoming crits.

This type of analysis was found to successfully predict whether new problem reports from a particular customer could be expected to become critical based on the historical pain indicators of other PMR for the same customer. This one-dimensional analysis (e.g. customer source) proved to be successful.

Similarly, product and service type were used to perform a second, single-dimensional validation on the new process, extracting PMR from a customer problem ticket database which all pertained to the same product or same service instead of pertaining to the same customer. Some products, such as newly launched products or products which are historically unstable, are potentially more likely to product problem tickets which escalate more often that older, stable products, for example. Again, the analysis was successful in predicting with a considerable accuracy which of the problem tickets would have become critical.

### Analysis Modules, Validation and Training

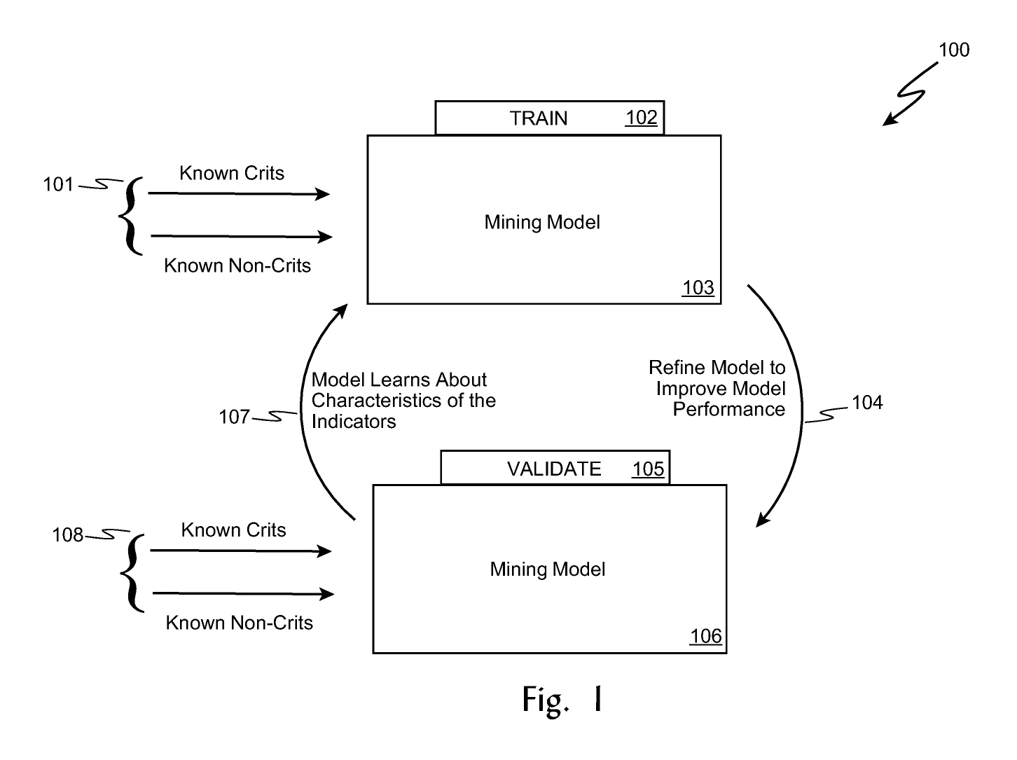

Turning to FIG. 1, for the testing and validation, a set of extracted PMRs (101), some which were known to have eventually escalated to critical level and others which were known not to have escalated to critical level, were input into the data mining model (102, 103) which was trainable. Its initial predictions were output (104) to a validation mining model (105, 106) receiving extracted PMRs (108) for comparison. Feedback (107) regarding whether or not the output predictions (104) were correct or not was provided to the trainable mining model (103), which then updated its training, and subsequently produced new prediction outputs (104).

These new prediction outputs (104) were then validated, and feedback (107) was provided to the training, in order for the analysis modules to automatically learn and adapt to the characteristics of the pain indicators for the particular set of inputs. In the case of feeding the analysis modules PMRs extracted for the same customer, it learned automatically what the pain indicators were for that particular customer. In the case of feeding the analysis modules PMRs extracted for the same product or service type, it learned automatically what the pain indicators were for that product or for that service.

### Analytical Methods

The prototype analysis modules were constructed using several analytical models, including:
(a) Logistical Regression;
(b) Classification Trees;
(c) Neural Nets;
(d) K^{th} Nearest Neighbor; and
(e) Discriminant Analysis

We found Logistical Regression and Discriminant Analysis to provide acceptable results and relatively straightforward to implement. However, these other analytical models, as well as others, may also be useful for alternative embodiments.

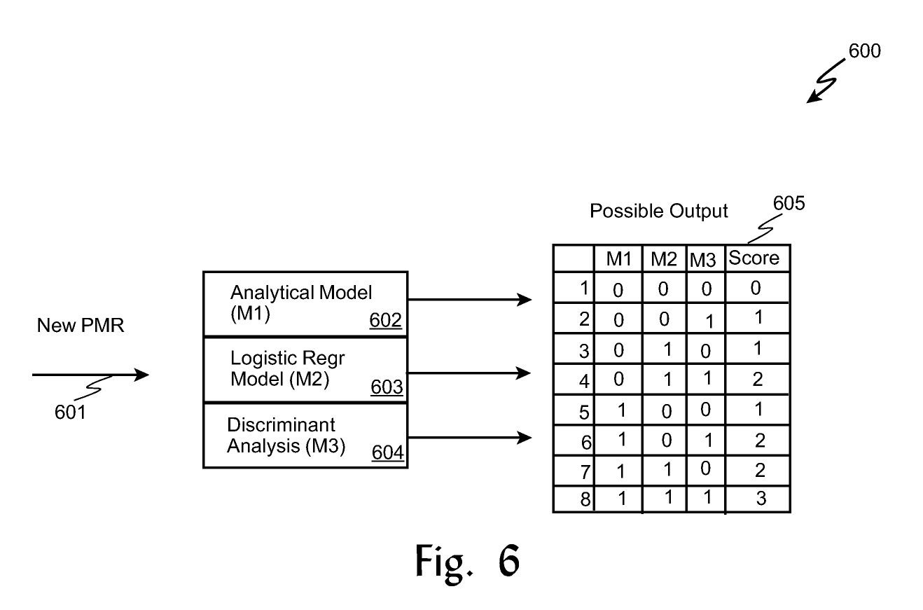

In FIG. 6, our hybrid model (600) implemented in our prototype is shown, in which new PMRs (601) are received and processed by three analysis modules (602, 603, 604), with the output (605) being a weighted combination of the outputs of the three analysis modules.

### Experimental Results

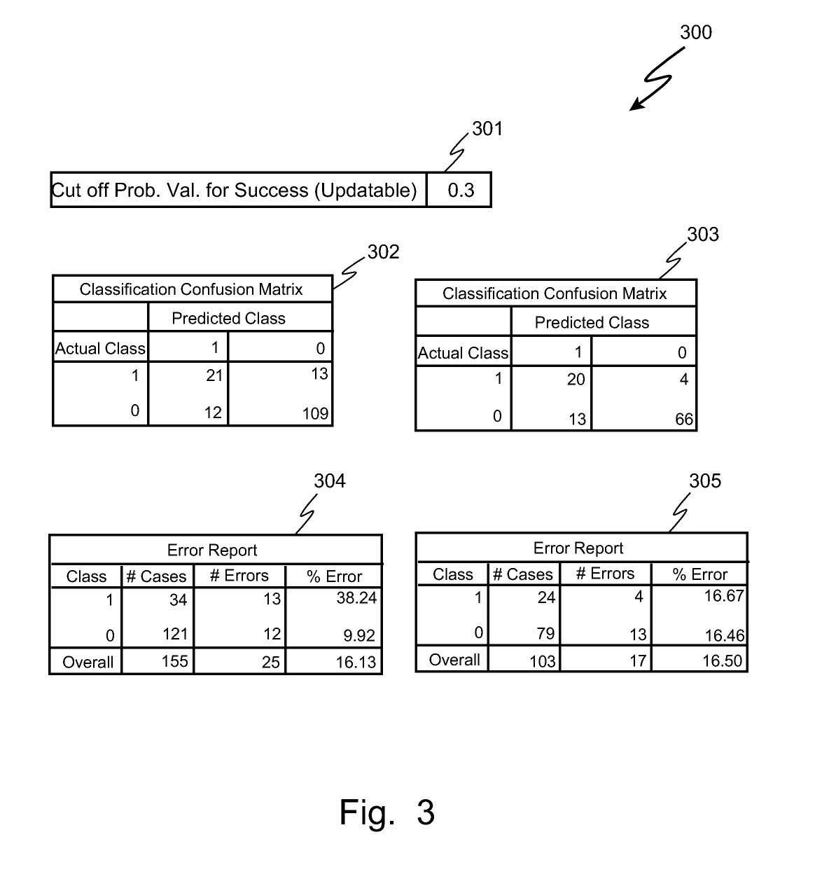

Turning to FIG. 3, we present the actual results of one experiment which we refer to as “Model 1”. The results of the training alone can be misleading due to over-fitting noise in the data. Of greater interest and utility is the accuracy of our model's “Class 1” which represents the class of PMRs which eventually turned critical.

In this particular test result, 34 problems associated with Crits were included n the test sample, out of which 23 problems were predicted to become Crits (67.6%), an average of 24 Call Records were created before the problems were classified as critical (e.g. the customer contacted the supplier 24 times before the PMR was declared critical under the traditional method). But, our analysis module would have flagged the PMRs an average of 10 days prior to when the actual status was changed to critical.

TABLE 1
Example of an Actual PMR Which Went Critical

| Date | Traditional Method (Actual) | With Invention (Predicted) |
|---|---|---|
| 08/14 | Initial PMR Opened | Initial PMR Opened |
| 08/16 | Escalated to Level 3 | |
| 08/17 | System crash | Three Analysis Modules |
| | | filters would have |
| | | triggered, suggesting an |
| | | early re-classification of |
| | | the PMR as critical. |
| | PMR has been in 8 Different | |
| | Queues in 3 Days | |
| | 5 Secondary PMRs Generated | |
| | Previous PMR with Same Problem/ | |
| | Same Customer | |
| | Problem Now Occurring on Multiple | |
| | Production Machines | |
| 08/23 | Re-classified as critical (actual) | |

As can be seen from this chart, all of the events following August 17 until August 23 could have possibly been avoided by declaring the PMR critical using our new analysis modules and their predictive outputs using a cut-off probability value for success of 0.3, as illustrated by the confusion matrices (302, 303) containing information about the predicted and actual classification outputs are shown, including a analysis of the errors of the models (304, 305). As can be seen from these error reports, the output of the trained predictor regarding predicted critical PMR's was only about 16.5%, which we consider to be acceptably successful.

In actual operation, “live” or new PMRs would be input into the trained analysis modules, and an immediate output would predict whether or not the new PMR would be expected to eventually “go critical”. If so, it could be escalated immediately, by passing the usual delays and frustrations of requiring the PMR to pass through each level of escalation sequentially.

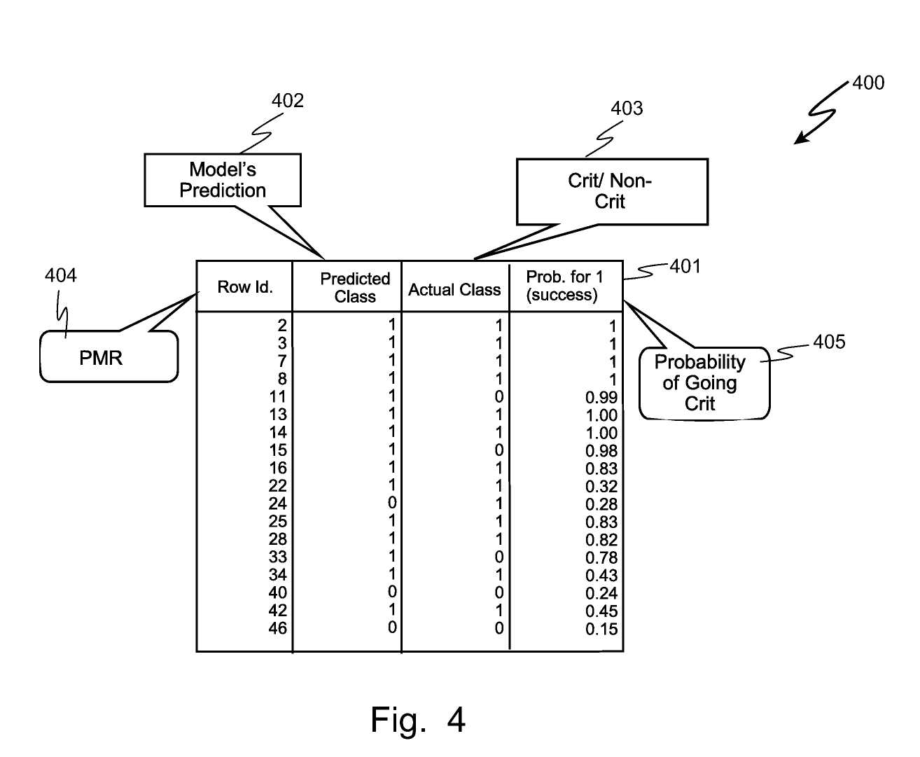

FIG. 4 provides details of the underlying results (400) shown in FIG. 3, where the “row ID” (404) relates directly to a particular extracted PMR, the predicted class (402) is the output of the analysis module (1=expected to become critical, 0=expected not to become critical), the actual class (403) is the actual final result for a final resolution or status of each PMR, and the probability (401) is the output of the analysis modules indicating the confidence level in the predicted class (1 being 100% confident, 0.15 being not very confident at all).

So, the cut off value (301) used in FIG. 3 of 0.3 generates a predicted class for each PMR for which the probability of going critical (401) is at or above 0.3, particularly rows 2-22, 35-34, and 42 (note that some row numbers are skipped). Conversely, PMRs for which the probability of going critical (401) is less than the cut off value (0.3 in this example) are predicted not to go critical (predicted class=0), namely rows 24, 40 and 46 in this example. Row numbers which are skipped represent PMRs which were not included in the test, or which were outliers for reasons unrelated to the analysis modules outputs.

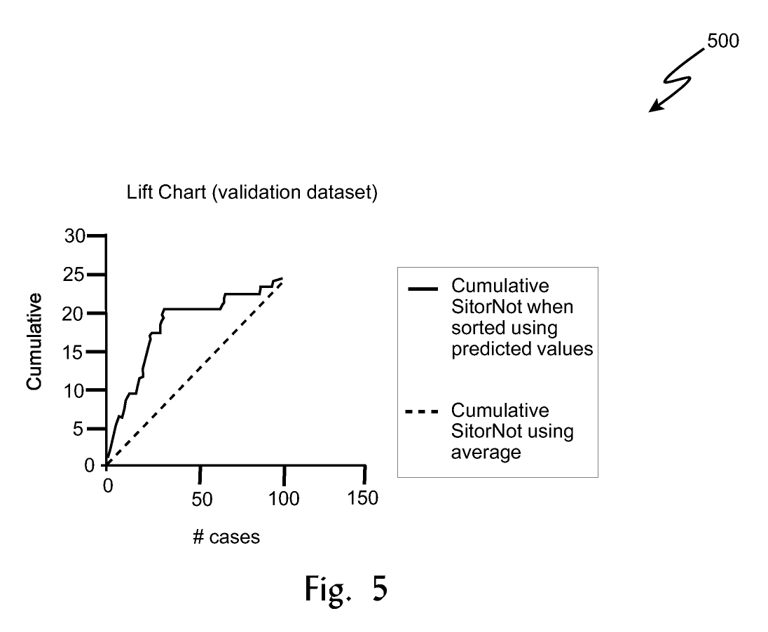

Turning now to FIG. 5, a lift chart showing the effectiveness of our analysis modules as a ratio between the results if the model had been used on the extracted PMR and the (actual) results that were obtained without our analysis modules. The straight dashed line shows the escalation that actually occurred with the selected PMR (e.g. the validation input), and the solid line shows the early escalation that would have occurred had the analysis modules been employed early in the life cycle of the handling of the extracted PMRs.

In practice, when “live” or new PMRs are input into the analysis modules instead of historical, already-resolved PMRs, these predictive outputs and the cut off thresholds would be used to prioritize action and to “prematurely” escalate PMRs which are expected to become critical eventually.

Thus, by predicting and escalating in advance, a customer service department and act proactively and actually preempt much of the frustration and loss of customer satisfaction that might otherwise occur using the traditional methods of escalation.

### Data Collection

According to our prototype embodiment of the invention, the following information was captured and input into the analysis modules as part of the Problem Management Records:
(a) Customer pain level index, such as 1-10, with 1 being the \ customer being very happy at the moment or very little felt criticality of the reported problem, and 10 being customer being very unhappy or being extremely concerned about the possible impact of the reported problem.
(b) The historic inherent delays in the support process.
(c) An gap index provided by the customer signaling differences in customer expectation versus previous service delivery (e.g. 1-10, 1 being the customer expects that the service will be delivered in a timely fashion and accurately, and 10 being the customer does not expect that service will be delivered timely or accurately).

For the data mining models, we utilized the following input criteria:

(a) Initial Severity Rating (e.g. When the customer reported the problem, what was the perceived severity?)

(b) System Up/Down indicator (e.g. Was/were the System(s) involved experiencing down time?)

(c) Priority Change (e.g. Did the problem record go thru severity changes?)

(d) Update Call Count (e.g. how many times did the customer call to get updates on the problem record?)

(e) Current Severity Rating (e.g. What is the current severity?)

(f) Component Criticality (e.g. Is the problem record open against a critical component?)

(g) Priority Rating as the PMR was escalated to Level 2 support.

(h) Delay to escalation to Level 2.

(i) Update Frequency (e.g. a responsiveness measure regarding how long it is taking between updates to the problem record).

In other embodiments, we believe or expect that the following factors may also be useful for incorporation into the analysis modules:

(j) Customer Propensity to Escalate (e.g. What is the propensity of the customer to escalate problem as a crit?)

(k) Revenue Impact (e.g. What's the size of the sales pipeline for the customer? What's the past sales history?)

(l) Total Pain Index (e.g. What's the total pain level for the customer considering all the problem records currently open as opposed to the pain level from a single problem record?)

(m) Departments Touched Count (e.g. How many divisions within support has the problem bounced?)

(n) Queues Experienced Count (e.g. How many different support queues has the problem gone through?)

### Computer Program Product

As will be appreciated by one skilled in the art, aspects of the present invention may be embodied as a system, method or computer program product. Accordingly, aspects of the present invention may take the form of an entirely hardware embodiment, potentially employing customized integrated circuits, or an embodiment combining software (software, modules, instances, firmware, resident software, micro-code, etc.) with suitable logical process executing hardware (microprocessor, programmable logic devices, etc.).

Furthermore, aspects of the present invention may take the form of a computer program product embodied in one or more computer readable memories having computer readable program code embodied or encoded thereon or therein.

Any combination of one or more computer readable memories may be utilized, such as Random Access Memory (RAM), Read-Only Memory (ROM), hard disk, optical disk, removable memory, and floppy disks. In the context of this document, a computer readable storage memory may be any tangible medium that can contain, or store a program for use by or in connection with an instruction execution system, apparatus, or device.

Computer program code for carrying out operations for aspects of the present invention may be written in any combination of one or more programming languages, including, but not limited to, an object oriented programming language such as Java [TM], Smalltalk [TM], C++ [TM]or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions executed by a microprocessor, or alternatively, as a part or entirety of a customized integrated circuit. These computer program instructions may be provided to a processor of a or other programmable data processing apparatus to produce a machine, such that the instructions, which execute via the processor of the computer or other programmable data processing apparatus, create a tangible means for implementing the functions/acts specified in the flowchart and/or block diagram block or blocks.

These computer program instructions may also be stored in a computer readable memory that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The several figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Regarding computers for executing the logical processes set forth herein, it will be readily recognized by those skilled in the art that a variety of computers are suitable and will become suitable as memory, processing, and communications capacities of computers and portable devices increases. Common and well-known computing platforms such as “Personal Computers”, web servers such as an IBM iSeries server, and portable devices such as personal digital assistants and smart phones, running a popular operating systems such as Microsoft [TM] Windows [TM] or IBM [TM] AIX [TM], Palm OS [TM], Microsoft Windows Mobile [TM], UNIX, LINUX, Google Android [TM], Apple iPhone [TM] operating system, and others, may be employed to execute one or more application programs to accomplish the computerized methods described herein. Whereas these computing platforms and operating systems are well known an openly described in any number of textbooks, websites, and public “open” specifications and recommendations, diagrams and further details of these computing systems in general (without the customized logical processes of the present invention) are readily available to those ordinarily skilled in the art.

### CONCLUSION

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

It will be readily recognized by those skilled in the art that the foregoing example embodiments do not define the extent or scope of the present invention, but instead are provided as illustrations of how to make and use at least one embodiment of the invention. The following claims define the extent and scope of at least one invention disclosed herein.

What is claimed is:

1. A computer program product for predicting the likelihood of a problem report being escalated to a critical status in a customer service environment, the computer program product comprising:
a computer readable storage memory having computer readable program code embodied therewith, the computer readable program code configured to:
receive by one or more analysis modules one or more historical Problem Management Records for which associated problems have been resolved and final criticality statuses have been determined;
analyze the received historical Problem Management Records by the analysis module using at least one trainable data mining process to produce a prediction output for each historical Problem Management Record by the analysis module;
validate the prediction output against the final criticality statuses;
train the data mining process according to the validation; and
subsequent to the analysis and training using the historical Problem Management Records:
receive an unresolved Problem Management Record;
analyze the unresolved Problem Management Record by the trained analysis module to produce a prediction indicator and a confidence indicator for unresolved Problem Management Record to be re-classified as critical status; and
escalate the unresolved Problem Management Record to critical status level responsive to the prediction indicator and the confidence indicator exceeding a predetermined threshold.

2. The computer program product as set forth in claim 1 wherein the trainable data mining process comprises a Logistical Regression process.

3. The computer program product as set forth in claim 1 wherein the trainable data mining process comprises a Discrimant Analysis process.

4. The computer program product as set forth in claim 1 wherein the trainable data mining process comprises a process selected from a group comprising Classification Trees processes, Neural Networks processes, and K-th Nearest Neighbor processes.

5. The computer program product as set forth in claim 1 wherein a received Problem Management Record comprises one or more indicators and criteria selected from a group comprising a customer pain level index, a historic inherent delay indicator, a customer expectation gap an initial severity rating indicator, a system up/down indicator, a priority change flag, a status update query telephone call count, a current severity rating, a component criticality indicator, and a status update frequency.

6. The computer program product as set forth in claim 1 wherein the received historical Problem Management Records are selected, filtered, or sorted by customer ownership indicator wherein the training is performed on a dimension of a specific customer.

7. The computer program product as set forth in claim 1 wherein the received historical Problem Management Records are selected, filtered, or sorted by product identifier wherein the training is performed on a dimension of a specific product.

8. The computer program product as set forth in claim 1 wherein the received historical Problem Management Records are selected, filtered, or sorted by service identifier wherein the training is performed on a dimension of a specific service.

9. An automated method for predicting the likelihood of a problem report being escalated to a critical status in a customer service environment, comprising:
receiving by one or more analysis modules of a computer platform one or more historical Problem Management Records for which associated problems have been resolved and final criticality statuses have been determined;
analyzing by the analysis module the received historical Problem Management Records using at least one trainable data mining process to produce a prediction output for each historical Problem Management Record by the analysis module;
validating by the analysis module the prediction output against the final criticality statuses;
training the data mining process according to the validation; and
subsequently to the analysis and training using the historical Problem Management Records:
receiving an unresolved Problem Management Record;
analyzing the unresolved Problem Management Record by the trained analysis module to produce a prediction indicator and a confidence indicator for unresolved Problem Management Record to be re-classified as critical status; and
escalating the unresolved Problem Management Record to critical status level responsive to the prediction indicator and the confidence indicator exceeding a predetermined threshold.

10. The automated method as set forth in claim 9 wherein the trainable data mining process comprises a Logistical Regression process.

11. The automated method as set forth in claim 9 wherein the trainable data mining process comprises a Discrimant Analysis process.

12. The automated method as set forth in claim 9 wherein the trainable data mining process comprises a process selected from a group comprising Classification Trees processes, Neural Networks processes, and K-th Nearest Neighbor processes.

13. The automated method as set forth in claim 9 wherein a received Problem Management Record comprises one or more indicators and criteria selected from a group comprising a customer pain level index, a historic inherent delay indicator, a customer expectation gap an initial severity rating indicator, a system up/down indicator, a priority change flag, a status update query telephone call count, a current severity rating, a component criticality indicator, and a status update frequency.

14. The automated method as set forth in claim 9 wherein the received historical Problem Management Records are selected, filtered, or sorted by customer ownership indicator wherein the training is performed on a dimension of a specific customer.

15. The automated method as set forth in claim 9 wherein the received historical Problem Management Records are selected, filtered, or sorted by product identifier wherein the training is performed on a dimension of a specific product.

16. The automated method as set forth in claim 9 wherein the received historical Problem Management Records are selected, filtered, or sorted by service identifier wherein the training is performed on a dimension of a specific service.

17. A system for predicting the likelihood of a problem report being escalated to a critical status in a customer service environment, comprising:
a computer platform suitable for executing logical processes of one or more more analysis modules;
a receiver portion of one or more analysis modules of a computer platform receiving one or more historical Problem Management Records for which associated problems have been resolved and final criticality statuses have been determined;
an analyzer portion of the analysis module analyzing the received historical Problem Management Records using at least one trainable data mining process to produce a prediction output for each historical Problem Management Record by the analysis module;
a validator portion of the analysis module validating the prediction output against the final criticality statuses;
a trainer portion of the analysis module training the data mining process according to the validation; and
a predictor portion of the analysis module, subsequently to the analysis and training using the historical Problem Management Records:
receiving an unresolved Problem Management Record;
analyzing the unresolved Problem Management Record by the trained analysis module to produce a prediction indicator and a confidence indicator for unresolved Problem Management Record to be re-classified as critical status; and
escalating the unresolved Problem Management Record to critical status level responsive to the prediction indicator and the confidence indicator exceeding a predetermined threshold.

18. The system as set forth in claim 17 wherein the trainable data mining process comprises a Logistical Regression process.

19. The system as set forth in claim 17 wherein the trainable data mining process comprises a Discrimant Analysis process.

20. The system as set forth in claim 17 wherein the trainable data mining process comprises a process selected from a group comprising Classification Trees processes, Neural Networks processes, and K-th Nearest Neighbor processes.

21. The system as set forth in claim 17 wherein a received Problem Management Record comprises one or more indicators and criteria selected from a group comprising a customer pain level index, a historic inherent delay indicator, a customer expectation gap an initial severity rating indicator, a system up/down indicator, a priority change flag, a status update query telephone call count, a current severity rating, a component criticality indicator, and a status update frequency.

22. The system as set forth in claim 17 wherein the received historical Problem Management Records are selected, filtered, or sorted by customer ownership indicator wherein the training is performed on a dimension of a specific customer.

23. The system as set forth in claim 17 wherein the received historical Problem Management Records are selected, filtered, or sorted by product identifier wherein the training is performed on a dimension of a specific product.

24. The system as set forth in claim 17 wherein the received historical Problem Management Records are selected, filtered, or sorted by service identifier wherein the training is performed on a dimension of a specific service.
